(19) United States
(12) Patent Application Publication
(10) Pub. No.: US 2014/0355869 A1
(43) Pub. Date: Dec. 4, 2014

(54) SYSTEM AND METHOD FOR PREVENTING AIRCRAFTS FROM COLLIDING WITH OBJECTS ON THE GROUND

(71) Applicant: ELBIT SYSTEMS LTD., Haifa (IL)

(72) Inventors: Yariv GERSHENSON, Haifa (IL); Oran REUVENI, Yoqneam Illit (IL); Itay COHEN, Tel Aviv (IL)

(73) Assignee: ELBIT SYSTEMS LTD., Haifa (IL)

(21) Appl. No.: 14/292,978

(22) Filed: Jun. 2, 2014

(30) Foreign Application Priority Data
Jun. 3, 2013 (IL) 226700

(51) Int. Cl. G06T 7/00

(52) U.S. Cl. CPC G06T 7/0046
USPC 382/154

(57) ABSTRACT

A safety system for preventing aircraft collisions with objects on the ground is provided herein. The safety system may include gated imaging sensors attached to the aircraft that capture overlapping gated images which are images that allow estimating the range of the imaged objects. The overlap zones are utilized to generate a three dimensional model of the aircraft surroundings. Additionally, aircraft contour data and aircraft kinematic data are used to construct an expected swept volume of the aircraft which is then projected onto the three dimensional model of the aircraft surroundings to derive an estimation of likelihood of collision of the aircraft with objects in its surroundings and corresponding warnings.

### CROSS-REFERENCE TO RELATED APPLICATIONS

This application claims the benefit of Israel Patent Application No. 226700, filed Jun. 3, 2013, which is hereby incorporated by reference

### FIELD OF THE INVENTION

The present invention relates to the field of aircraft safety, and more particularly, to a ground collision warning system.

### BACKGROUND OF THE INVENTION

Aircraft safety on the ground is an important operative issue, which is essential to airport functioning. U.S. Pat. No. 8,121,786 discloses determining collision risks using proximity detectors and a communication system that receives object presence indications therefrom and generates a corresponding acoustic alarm.

### SUMMARY OF THE INVENTION

One embodiment of the present invention provides a safety system for preventing aircraft collisions with objects on the ground, the safety system comprising: (i) at least two gated imaging sensors attached to the aircraft and configured to capture at least two corresponding images of an aircraft surroundings, the images having an overlap zone of surrounding that is captured by at least two of the at least two gated imaging sensors, (ii) a model generator in communication with the at least two gated imaging sensors and arranged to receive the at least two images therefrom and derive a three dimensional model of at least the overlap zone from the at least two images, (iii) a contour estimator arranged to calculate, from obtained contour data of the aircraft and from obtained kinematic data of the aircraft, an expected swept volume of the aircraft, and (iv) a decision module in communication with the model generator and with the contour estimator and arranged to estimate, by analyzing the expected swept volume of the aircraft on the three dimensional model, a likelihood of collision of the aircraft with objects in its surroundings.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic illustration block diagram of a safety system for preventing aircraft collisions with objects on the ground, according to some embodiments of the invention,

FIG. 2 is a high level schematic flow diagram of safety system, illustrating modules and data in safety system, according to some embodiments of the invention, and

FIGS. 3, 4A and 4B are high level flowcharts illustrating a method of preventing aircraft collisions with objects on the ground, according to some embodiments of the invention.

### DETAILED DESCRIPTION OF THE INVENTION

Prior to setting forth the detailed description, it may be helpful to set forth definitions of certain terms that will be used hereinafter.

The term “gated imaging sensor” as used herein in this application refers to an imaging device that is equipped with a shutter that is configured to control the range from which reflected illumination is captured. For example, illumination may be carried out by light pulses and the shutter may be configured to be open at intervals that correspond to the roundtrip time of the pulses from the target. Gated imaging thus allows filtering out imaging data from irrelevant ranges, such as interfering objects or unwanted optical effects and disturbances. For example, fog may be filtered out by gated imaging by capturing only light reflected from objects at the given range that is defined by the timing of the shutter. The illumination may comprise a pulsed laser, and the shutter may operate electronically or optically. The term “gated image” as used herein in this application refers to an image captured by a gated imaging sensor.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

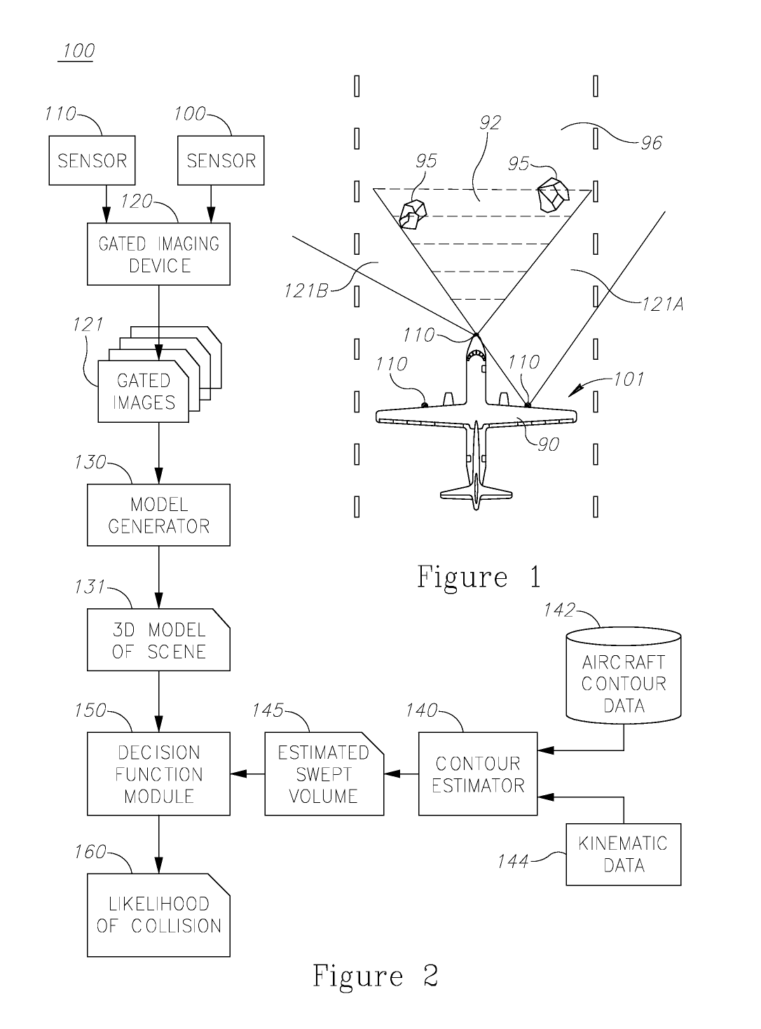

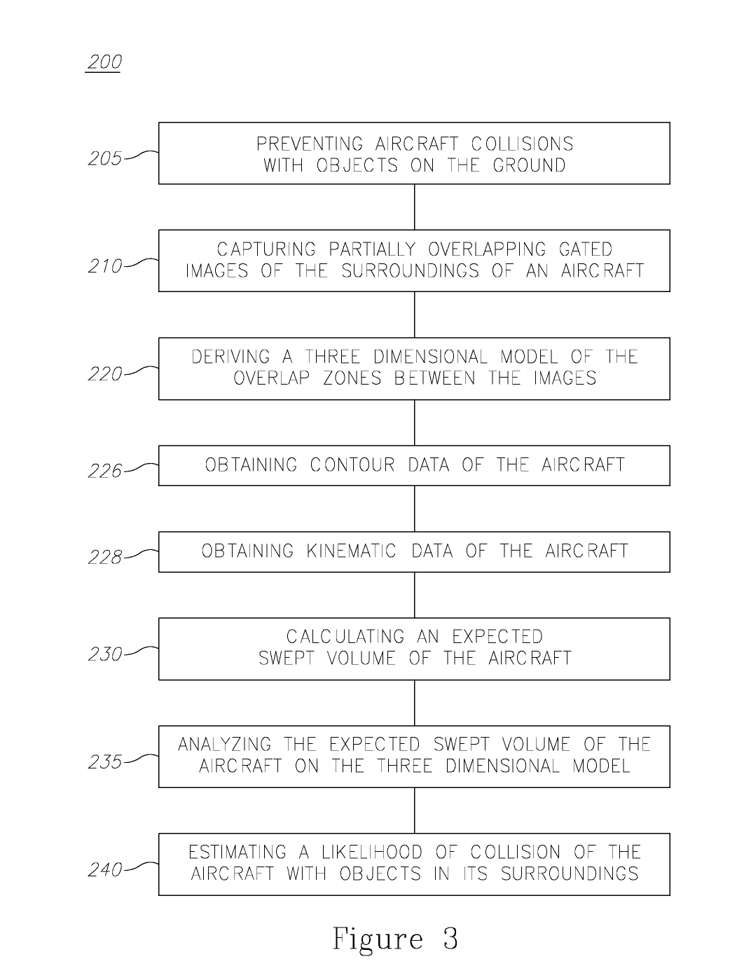

FIG. 1 is a high level schematic illustration block diagram of a safety system 100 for preventing aircraft collisions with objects on the ground, according to some embodiments of the invention. FIG. 2 is a high level schematic flow diagram of safety system 100, illustrating modules and data in safety system 100, according to some embodiments of the invention.

Safety system 100 comprises a plurality of gated imaging sensors 110 attached to an aircraft 90. Sensors 110 may be provided as a kit 101 for enhancing aircraft safety, or may be integrated on aircraft during production.

Gated imaging sensors 110 are configured to capture images of aircraft surroundings 96. Captured images 121 may be generated by a gated imaging device that receives raw data from gated imaging sensors 110. At least two of sensors 110 are positioned to capture at least partially overlapping images. For example, in FIG. 1, images 121A and 121B are captured by respective sensors 110 and have an overlap zone 92. As gated imaging provides a capturing range, using at least two partially overlapping images allows generating three dimensional data about aircraft surroundings 96. In particular, obstacles 95 in aircraft surroundings 96 may be imaged and their position may be estimated.

Safety system 100 further comprises a model generator 130 (FIG. 2) in communication with gated imaging sensors 110 and arranged to receive images therefrom. Model generator 130 is arranged to derive a three dimensional model 131 of at least the overlap zone from the images. In the example illustrated in FIG. 1, the three dimensional model may comprise overlap zone 92 and obstacles 95. Overlap zones may be multiple and relate to different sensors 110.

Safety system 100 further comprises a contour estimator 140 arranged to calculate, from obtained contour data 142 of aircraft 90 and from obtained kinematic data 144 of aircraft 90, an expected swept volume 145 of aircraft 90. Expected swept volume 145 describes the volume or the area aircraft 90 is expected to occupy at a given time. For example, contour estimator 140 may project contour data 142 to future time according to kinematic data 144 and according to expected changes in kinematic data 144, corresponding e.g. to the drive plan.

Safety system 100 further comprises a decision module 150 in communication with model generator 130 and with contour estimator 140. Decision module 150 is arranged to estimate, by analyzing expected swept volume 145 of aircraft 90 on three dimensional model 131, a likelihood of collision 160 of aircraft 90 with objects such as obstacles 95 in its surroundings 96.

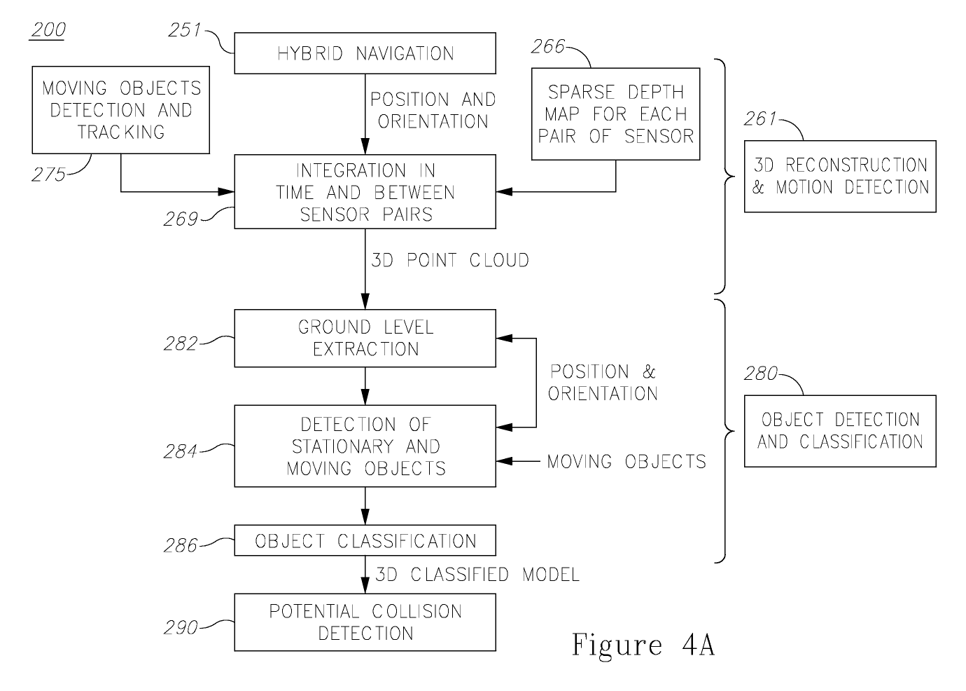

FIG. 3 is a high level flowchart illustrating a method 200 of preventing aircraft collisions with objects on the ground, according to some embodiments of the invention.

Method 200 may comprise the following stages of preventing aircraft collisions with objects on the ground (stage 205): capturing (stage 210), by gated imaging from at least two sources, at least two images of an aircraft surroundings, wherein the at least two sources are positioned to define an overlap zone of surrounding that is captured by at least two of the at least two images, deriving (stage 220) a three dimensional model of at least the overlap zone from the at least two images, calculating (stage 230), from obtained contour data of the aircraft (stage 226) and from obtained kinematic data of the aircraft (stage 228), an expected swept volume of the aircraft, and estimating (stage 240), by analyzing the expected swept volume of the aircraft on the three dimensional model (stage 235), a likelihood of collision of the aircraft with objects in its surroundings.

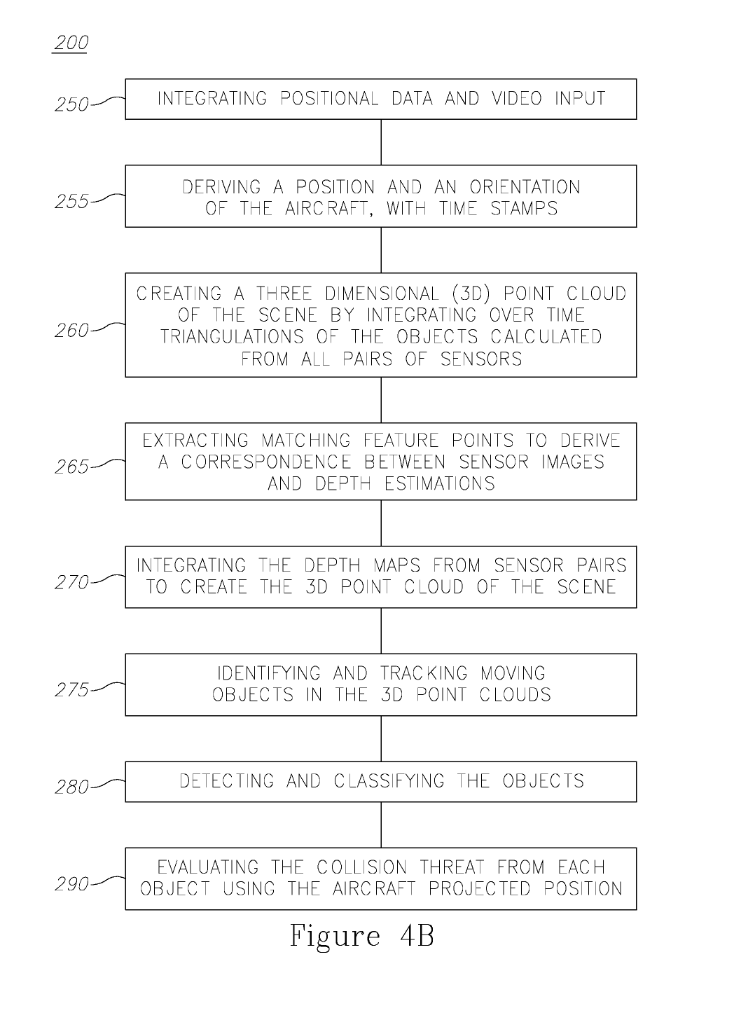

FIGS. 4A and 4B are high level flowcharts illustrating further stages in method 200, according to some embodiments of the invention.

Method 200 may comprise (i) a hybrid navigation algorithm that integrates GPS/INS (global positioning system/inertial system) data and video input to generate a reliable position and orientation (herein: P&O) of the aircraft at each time stamp; (ii) a 3D reconstruction that creates a 3D point cloud of the scene by integrating over time the triangulation created from each pair of sensors and detects and tracks moving objects; (iii) object detection and classification; and (iv) an algorithm (possibly but not necessarily fuzzy logic) that evaluates the collision threat from each object using the aircraft projected position according to the navigation solution vector and the objects' motion vectors.

In some embodiments, method 200 comprises integrating positional data and video input (stage 250), and deriving by hybrid navigation 251 a position and an orientation of the aircraft with time stamps (stage 255) that comprise corresponding navigation solution vectors.

For example, video images may undergo some basic image enhancement and preliminary processing such as lens distortion correction. The processed video may be used in this stage as well as all the following. A geo-registered camera position and orientation may be estimated for each frame of each camera. This is done via a hybrid algorithm that finds a consensus between P&O calculation based on 2D video tracking and P&O calculation from GPS & INS samples.

P&O calculation based on 2D video tracking may be carried out by extracting and tracking separately feature points for each video, i.e., a 2D-2D point correspondences in consecutive video frames is determined. Using this matched set of points, the camera trajectory is evaluated, and hence the new camera position can be found (in reference to its initial position). In a non-limiting example, the steps of this stage include: Feature detection (for example with Harris corner detection); establishing initial set of matches (for example using correlation); finding robust correspondences (using relaxation techniques and Epipolar Geometry constraint); and using robust correspondence and sensors intrinsic parameters to evaluate the extrinsic parameters.

P&O calculation based GPS and INS samples may be carried out as following. GPS and INS inputs are in principal sufficient for position and orientation calculation. GPS observations can be used to derive the sensor position, and INS attitude can be used to derive the tilt of the sensor. However, due to unexpected behavior of these measurements, they may be integrated with each other and with P&O calculations from video tracking in order to obtain reliable observations. The general approach to integrate the GPS and INS observations may be via Kalman filtering. Kalman filtering is a real-time optimal estimation method that provides the optimal estimate of the system based on all past and present information.

In some embodiments, method 200 comprises creating a three dimensional (3D) point cloud of the scene by integrating over time triangulations of the objects calculated from each pair of sensors (stage 260). 3D reconstruction and motion detection 261 may comprise extracting matching feature points to derive a correspondence between sensor images and depth estimations (stage 265), and integrating the depth maps from sensor pairs to create the 3D point cloud of the scene (stage 270) to identify and track moving objects in the 3D point clouds (stage 275). This may be carried out by integrating in time and between sensor pairs 269, sparse depth maps for each pair of sensors 266, detection and tracking data of moving objects 275 and position and orientation data.

The methodology may be used to create the 3D map by integrating depth maps created by different sensor pairs at different time steps. A subsidiary of this method is that the detection of moving objects is inherent in the calculations (stages 266, 275 and 269 in FIG. 4B). For each pair of sensors, at each time stamp, feature points may be extracted and correspondences may be determined between the two images. Using this matched set of points and the sensors' intrinsic and extrinsic parameters, the depth (in real world coordinates) of each corresponding pair of points can be determined. This stage comprises feature detection (for example with Harris corner detection), establishing an initial set of matches (for example using correlation), finding robust correspondences (e.g., using relaxation techniques and Epipolar Geometry constraint), and using robust correspondence and sensors' extrinsic parameters (that were calculated in the previous stage) to calculate a sparse depth map.

Moving objects may be inferred from the background via smart subtraction of consecutive images from the same sensor, after accounting for the sensor movement by warp. Integration in time and between sensor pairs may be carried out by coupling each point in the depth maps calculated for each sensor pair at each frame with a confidence grade. This grade may then be used to integrate all the depth points into one point cloud indication the 3D depth of the integrated scene, while excluding outliers and points with low confidence. The depth information at locations of moving objects is integrated differently at this stage, taking into account the evaluated velocity of the moving objects.

The output of this stage is a point cloud indication of the 3D structure of the scene and indications of moving objects and their trajectory.

The constructed 3D point cloud may then be used for detecting and classifying the objects (stage 280) that comprises extraction of the ground level 282 (enhanced by position and orientation data), detection of stationary and moving objects 284 (enhanced by position and orientation data as well as by moving objects data), and object classification 286 to construct a 3D classified model that is used for evaluating the collision threat from each object using the aircraft projected position (stage 290).

Object classification may comprise ground level extraction—based on position and orientation data and scene features; detection of objects—based on data features; and object classification—by comparison to an existing 3D database of potential objects at airports and learning object features. Potential collision detection may use as input the aircraft navigation solution and the 3D map of the objects in the arena as calculated in previous steps, including indication of moving objects and their trajectories. Objects are then placed on a relative map of the arena together with the aircraft. A table of existing and relevant objects and their parameters may be managed, and potentially new objects may be verified against this table, and consequently the table updates constantly. The aircraft projected position may be updated according to the navigation solution vector. Based on all this information, the algorithm (possibly but not necessarily the fuzzy logic algorithm) checks if the projected position of the aircraft is in collision path with other object, and produces air warnings as required.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Some embodiments of the invention may include features from different embodiments disclosed above, and some embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A safety system for preventing aircraft collisions with objects on the ground, the safety system comprising:
at least two gated imaging sensors attached to the aircraft and configured to capture at least two corresponding images of an aircraft surroundings, the images having an overlap zone of surrounding that is captured by at least two of the at least two gated imaging sensors,
a model generator in communication with the at least two gated imaging sensors and arranged to receive the at least two images therefrom and derive a three dimensional model of at least the overlap zone from the at least two images,
a contour estimator arranged to calculate, from obtained contour data of the aircraft and from obtained kinematic data of the aircraft, an expected swept volume of the aircraft, and
a decision module in communication with the model generator and with the contour estimator and arranged to estimate, by analyzing the expected swept volume of the aircraft on the three dimensional model, a likelihood of collision of the aircraft with objects in its surroundings.

2. A method of preventing aircraft collisions with objects on the ground, the method comprising:
capturing, by gated imaging from at least two sources, at least two images of an aircraft surroundings, wherein the at least two sources are positioned to define an overlap zone of surrounding that is captured by at least two of the at least two images,
deriving a three dimensional model of at least the overlap zone from the at least two images,
calculating, from obtained contour data of the aircraft and from obtained kinematic data of the aircraft, an expected swept volume of the aircraft, and
estimating, by analyzing the expected swept volume of the aircraft on the three dimensional model, a likelihood of collision of the aircraft with objects in its surroundings.

3. A method of preventing aircraft collisions with objects in a scene, the method comprising:
deriving, repeatedly, a position and an orientation of the aircraft by integrating positional data and video input from a plurality of gated imaging sensors;
creating a three dimensional (3D) point cloud of the scene by integrating over time triangulations of the objects calculated from each pair of sensors;
detecting and classifying the objects in the 3D point cloud; and
evaluating a collision threat from each object by projecting the derived aircraft position and orientation.

4. The method of claim 3, wherein the creating the 3D point cloud of the scene comprises extracting matching feature points to derive a correspondence between sensor images and depth estimations and integrating depth maps from sensor pairs.

5. The method of claim 3, further comprising deriving a ground level from the 3D point cloud and detecting and classifying the objects with respect thereto.
